(19) United States
(12) Patent Application Publication
(10) Pub. No.: US 2022/0369545 A1
(43) Pub. Date: Nov. 24, 2022

(54) SLOPE COMPENSATION FOR AUTONOMOUS LAWN MOWER PLANNER SYSTEM

(71) Applicant: Scythe Robotics, Inc., Longmont, CO (US)

(72) Inventors: Evan Thomas KAUFMAN, Erie, CO (US); Zachary Austin GOINS, Boulder, CO (US); John Gordon MORRISON, Longmont, CO (US)

(21) Appl. No.: 17/326,867

(22) Filed: May 21, 2021

(51) Int. Cl. A01D 34/00; A01D 34/86; G05D 1/00; G05D 1/02; G01D 21/00

(52) U.S. Cl. CPC A01D 34/008; A01D 34/86; G05D 1/0088; G05D 1/0219; G05D 1/0231; G05D 1/0257; G01D 21/00; A01D 2101/00

(57) ABSTRACT

Systems and techniques for compensating for the forces exerted on the autonomous lawn mower exerted by operating on a sloped region to be mowed are provided herein. In some examples, such systems and techniques may include receiving a coverage plan of an area to be mowed that includes a sloped region, determining, based on data for the one or more sensors, an orientation of the autonomous lawn mower and determining a slope force to compensate for the slope on which the autonomous lawn mower is operating. The slope force is then converted into signals to generate torques at one or more wheels to compensate for the slope.

### BACKGROUND

Certain tasks performed by autonomous lawn mower (ALM) systems require the mower to traverse the entirety of a given region. In many cases, the given region, or a portion thereof, may be on a slope or hill. When the mower tries to go up or down hills or traverse laterally across hills, a significant force and/or moment is exerted on the mower due to gravity. Such forces and/or moments may cause the mower to, for example, stall, flip over, go out of control, or create areas of cut or uncut lawn which are not aesthetically pleasing and/or unresolved.

### BRIEF DESCRIPTION OF THE DRAWINGS

The detailed description will now be described, by way of examples, with reference to the accompanying drawings, where like numerals denote like elements, a leftmost numeral indicates the original figure in which the element is found, and in which:

FIG. 1 illustrates an example of an autonomous lawn mower following a coverage pattern to mow a given sloped area, in accordance with some examples of the present disclosure.

FIG. 2A illustrates the mapping of slope forces and moments on the body of an autonomous lawn mower to wheel torques, in accordance with some examples of the present disclosure.

FIG. 2B illustrates a two-dimensional rear view of the mapping of slope forces and moments on the body of an autonomous lawn mower to wheel torques, in accordance with some examples of the present disclosure.

FIG. 3 is an example flow diagram for controlling an autonomous lawn mower over a sloped region to be mowed area, in accordance with some examples of the present disclosure.

FIG. 4 depicts an example system for controlling an autonomous lawn mower over a sloped region to be mowed area, in accordance with some examples of the present disclosure.

### DETAILED DESCRIPTION

The following detailed description describes techniques (e.g., methods, processes, and systems) for slope compensation for autonomous lawn mower planner system. In some examples, where a preexisting topology of the region that will be traversed is not known or available, the slope compensation may be determined while mowing. In other examples, a map of the area to be traversed (which may include topographical information) may be obtained or determined prior to mowing and analyzed to determine an optimal control system plan to operate the autonomous lawn mower over the sloped region. In examples where slope compensation is determined while mowing, localization is used to get an accurate pose of the mower (i.e., any one or more of a roll, pitch, yaw, x-, y-, or z-coordinate). The forces and moments on the autonomous lawn mower (e.g., due to gravity) of the autonomous lawn mower are calculated and compensated for by, for example, altering the torque applied to each wheel. That is, those calculated forces and moments are used to determine how the control system will operate the mower to navigate the sloped region. For example, the body forces and body moments calculated will be transformed to wheels torques that the control system uses to propel the autonomous lawn mower, while maintaining a persistent trajectory across the sloped regions to be mowed. As will be further described, by compensating for the forces exerted on the autonomous lawn mower exerted by operating on a sloped region to be mowed, the control system advantageously is able to consistently, efficiently, and safely control the mower wheels to follow a single stripe or a curve along the sloped region and to control error for that stripe of grass being mowed.

The techniques described in detail above and below may improve the functioning of a computer. As a non-limiting example, the techniques may reduce the computational requirements (e.g., processing power, memory required, etc.) needed to control an autonomous lawn mower to safely and efficiently mow straight lines on a slope and follow an optimal path for a system to follow in order to traverse all spaces within a bounded sloped area.

Although described herein with respect to a lawn mower for purposes of illustration, the description is not meant to be so limiting. Any of the techniques, processes, and systems described herein may be used in conjunction with other agricultural and landscaping devices including, but not limited to weed eaters/whackers, edgers, trimmers, and the like, as well as any other power equipment or systems for covering an area. Details of such a system are described in detail below with respect to the figures.

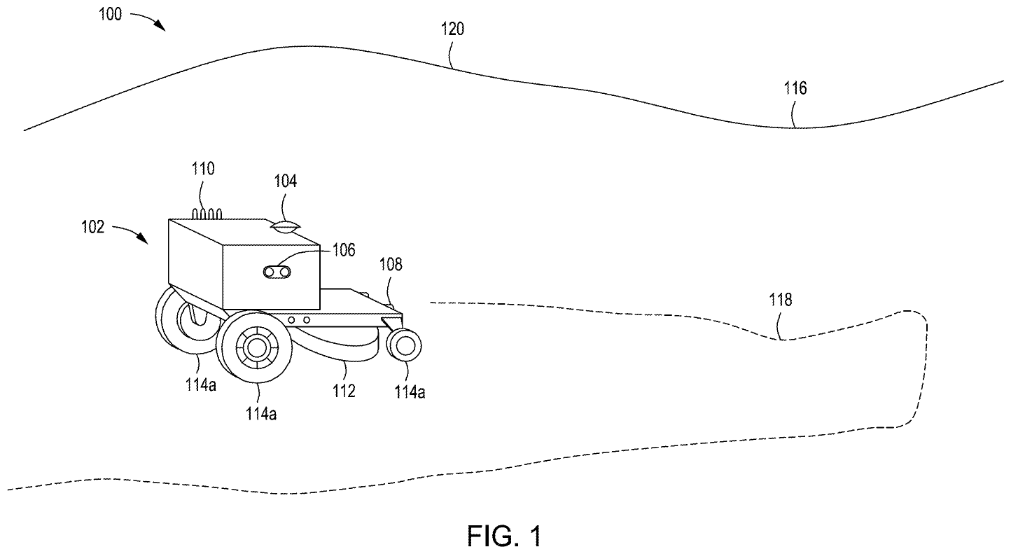

FIG. 1 illustrates an example of a system 100 for an autonomous lawn mower 102 to follow a mow pattern to mow a given region. The autonomous lawn mower 102 may comprise one or more sensors. As illustrated in FIG. 1, autonomous lawn mower is depicted with one or more Global Navigation Satellite System(s) (GNSS) 104, image sensors 106 (which may be RGB, monochromatic, infrared, ultraviolet, etc., as well as form the basis of stereo- (as depicted) or multi-view systems), and radar(s) 108. Though not depicted, the autonomous lawn mower 102 may comprise any other form of sensor for detecting environmental parameters and/or a state of the autonomous lawn mower 102 such as, but not limited to, lidar(s), inertial measurement unit(s) (IMU), accelerometer(s), gyroscope(s), magnetometer(s), wheel encoder(s), ultrasonic transducer(s), thermal imagers, ambient light sensor(s), time of flight sensors, barometer(s), bolometer(s), pyrometer(s), tilt sensor(s), and the like. Such sensors may be disposed about the autonomous lawn mower 102 in poses (i.e., positions and/or orientations) determined to optimize a field of view of all such sensors when combined. Image sensors 106 may comprise narrow field of view cameras and/or wide-angled cameras. Multiple image sensors 106 may be disposed about the autonomous lawn mower 102 to create various baselines (including dual baselines). All such sensors may be calibrated to determine one or more of intrinsics or extrinsics of the sensors.

The autonomous lawn mower 102 may further comprise, as depicted in the example illustrated, one or more antennae 110. Such antennae 110 may be used for one or more of wireless network communication, GNSS/GPS satellite reception, or any other form of electromagnetic signal transmission/reception.

The autonomous lawn mower 102 further comprises a deck 112. The deck 112 provides a housing for one or more blades in order to protect nearby objects from injury, to protect damage to the blades, as well as to control how vegetation is cut and directed after cut (e.g., to be ejected as mulch from the side of the deck 112, collected in a bag, or otherwise).

As depicted, the autonomous lawn mower 102 comprises a plurality of wheels 114. In at least some examples, two rear wheels 114(a) may be independently driven by one or more motors while front wheels 114(b) are attached on castors allowing them to freely rotate.

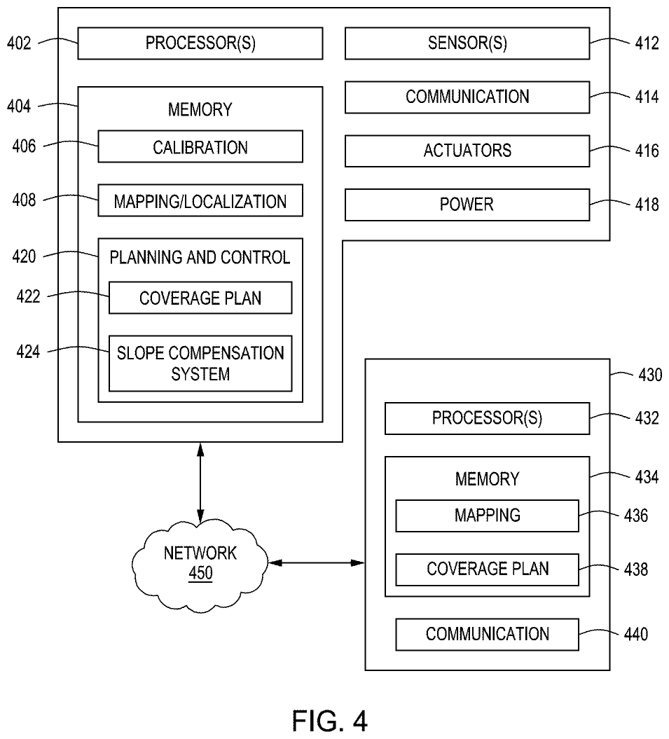

When mowing, in some examples, the autonomous lawn mower 102 may be provided with a coverage plan (e.g., 422 from FIG. 4) for the autonomous lawn mower to follow. Additional details of determining a coverage plan are described in detail in U.S. patent application Ser. No. 17/025,583 entitled “Coverage Planner” filed on Sep. 18, 2020, the entire contents of which are hereby incorporated. The coverage plan may comprise a path 118 and/or series of subpaths for the autonomous lawn mower 102 to traverse. The coverage plan may ensure that the autonomous lawn mower visits every region of the area bounded by perimeter 116 and, in at least some examples, in an efficient manner to minimize a total time to mow, an amount of energy required to mow, and/or so as to result in a desired aesthetically pleasing pattern. In various examples, the coverage plan may be generated agnostic of any topography of a given area, despite the fact that the coverage plan provided may traverse an area which includes slopes and hills 120. The slope compensation component will provide the necessary compensation values to the mower wheel controller in order to compensate for the presence of slopes and hills 120 and ensure the coverage plan is followed, while efficiently and safely controlling the mower wheels to follow a single stripe or a curve along the sloped region.

Slope compensation for the autonomous lawn mower begins using localization measurements and algorithms to get a current accurate estimate of orientation (e.g., roll, pitch, and/or yaw) of the mower based on the most recent measurements. In some examples, localization may be performed by Mapping/Localization components 408 described below with respect to FIG. 4. Determining the orientation by Mapping/Localization components 408 comprises, in at least some examples, determining the state of the lawn mower including any one or more of a roll, pitch, and/or yaw orientation and/or the surface orientation (e.g., normal) of one or more of a surface upon which the mower is currently positions or a surface proximate the lawn mower in a direction of travel of mowing. Measurements may be taken from one or more sensors onboard the lawn mower including, but not limited to, inertial measurement units (IMUs) (which, in turn, may comprise any one or more of accelerometers, gyroscopes, magnetometers, and the like), tilt meters, image sensors, lidar, radar, ultrasound, inclinometers, GPS measurements, wheel odometry, visual inertial tracking, and the like. Such measurements may be filtered (e.g., by a Bayesian filter, such as unscented Kalman filter (UKF), averaged, or otherwise processed) to remove noise. Sensor fusion techniques and algorithms may be used for combining complimentary sensors mounted on the autonomous lawn mowers for the position and attitude angle measurements.

While operating, the lawn mower may continuously measure a current orientation of the lawn mower (e.g., while mowing or otherwise traversing an area) using at least a subset of the sensors and determine an orientation of the mower. Measurement, in some examples, may comprise the same, or similar, filters or error rejection. Furthermore, in some examples, the autonomous lawn mower may receive additional data. As a non-limiting example, the system may receive additional sensor data (image data, lidar data, radar data, ultrasonic data, time of flight data, and the like), map data, or otherwise to determine an orientation of the surface upon which the lawn mower is travelling and/or a portion of the surface proximate the mower (e.g., along a direction of travel of the mower).

More specifically, in some examples, attitude estimation by the Mapping/Localization components 408 may be performed by combining accelerometer and magnetometer readings. Paired accelerometer readings and gyroscope readings may first be used to determine the state of the autonomous lawn mower (e.g., if mower is moving, etc.). If the state of the mower is determined to be moving based on the paired accelerometer and gyroscope readings, a GNSS velocity and/or wheel odometer velocity are used to calculate yaw instead of using the magnetometer. If the state of the mower is determined to be relatively still, magnetometer readings at that timestamp are interpolated. At that point, the attitude of the autonomous lawn mower is calculated using the accelerometer and magnetometer readings. In some examples, since the attitude estimation algorithms are fast, the system may only need to determine normalized acceleration and magnetometer vectors, and magnetic dip or calculation of expected world frame magnetic field are not needed. A short history of estimates that can be queried may be stored in memory. Such stored estimates may be used, for example, in error-checking, creating and/or updating maps, performing integrations for updates, or otherwise to improve the localization of the machine (either while traversing the region or during offline processing).

In some examples, the measurements and associated calculations used to determine the mower orientation are updated at 20-40 hertz intervals, or for example, at 30 Hertz intervals. Similarly, in some examples, the gravity vector and associated slope forces and slope moments, are updated at 20-40 hertz intervals, or for example, at 30 hertz intervals.

Once the orientation of the mower is determined, the gravity vector relative to the mower body of the mower is determined/estimated (e.g., by slope compensation component 424 of FIG. 4). The gravity vector relative to the mower body is used to (1) determine the slope force, either to be added or subtracted, to compensate for force required by the wheels to either go up or down slopes, and (2) determine the slope moment in order to compensate for the effects of that gravity vector with to the distance from those wheels to the center of mass of the mower. The determined instantaneous slope force and slope moment on the mower is used by a planning and control system (e.g., Planning and Control component 420) and mower subsystem actuators (e.g., Actuators 416) to consistently, efficiently, and safely control the autonomous lawn mower wheels to follow a single stripe or a curve along the sloped region and to control error for that stripe of grass being mowed. Thus, the inventive autonomous lawn mower using slope compensation can advantageously control the autonomous lawn mowers to safely and efficiently mow straight lines on a slope, as is described in further detail below with respect to the figures.

Specifically, given an actual or estimated mass of the autonomous lawn mower, and the distance from the center of the wheels to the center of mass of the mower, the slope forces and slope moments of the mower due to gravity can be determined. Those determined slope forces and moments can be mapped into torques of the two wheels that are used to control the mower (mower speed, motion, differential torque distribution between starboard and port wheels, etc.). That is, the unit vector for gravity relative to the body is transformed into a force on the wheels using the cross-product with that and the impact of gravity on the mower along the slope being traveled.

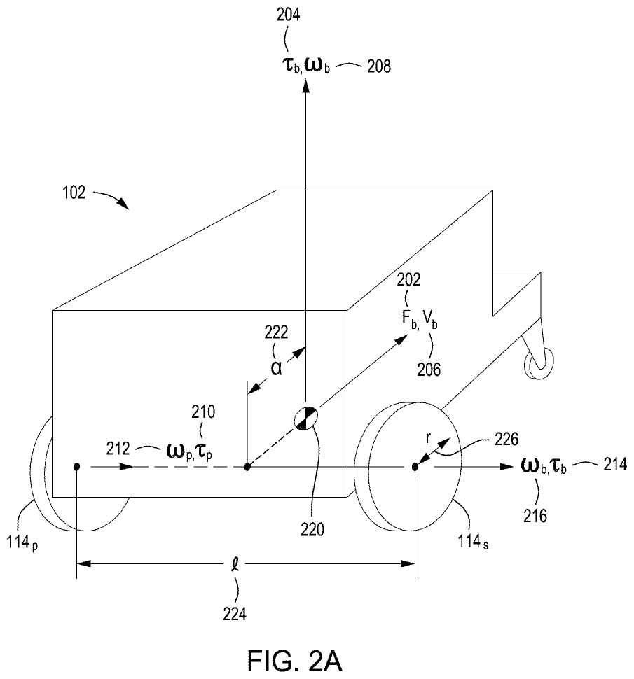

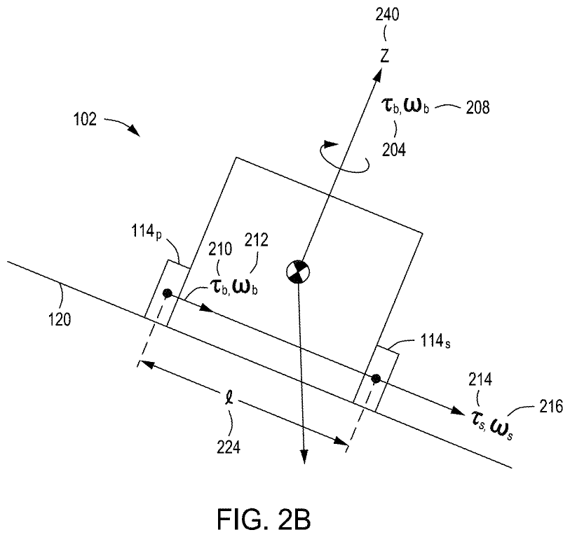

Specifically, FIG. 2A and FIG. 2B show the mapping of the slope forces F_{b} 202 and slope moments τ_{b 204} on the body of the autonomous lawn mower 102 to the wheel torques τₚ 210 and τₛ 214, where τₚ is the port side wheel torque, τₛ is the starboard side wheel torque, l 224 is the distance between the wheels 114, α 222 is the distance from the center of gravity 220 of the mower to the center-point between the wheels 114, and r 226 is the radius of the wheels 114. In at least some examples, the slope forces may be determined based on the estimated gravity vector and a model of the mower. In additional or alternative examples in which a map of the region is previously determined, the slope forces may be determined based at least in part on a surface normal associated with a current position of the mower with respect to the map. The force/torque mapping shown in FIG. 2A and 2B, and used by the Slope Compensation System 424 in FIG. 4, is as follows:

$${τ}_{p} = \frac{( \frac{1}{2} {F}_{b} - \frac{{τ}_{b}}{l} )}{r} \qquad Eq . 1$$

$${τ}_{s} = \frac{( \frac{1}{2} {F}_{b} + \frac{{τ}_{b}}{l} )}{r} \qquad Eq . 2$$

$${F}_{b} = \frac{( {τ}_{p} + {τ}_{s} )}{r} \qquad Eq . 3$$

$${τ}_{b} = \frac{l ( {τ}_{s} - {τ}_{p} )}{2 r} \qquad Eq . 4$$

FIG. 2A and FIG. 2B also illustrates the mappings of the autonomous lawn mower linear and angular velocity to the wheel angular velocities, where v_{b} is the linear velocity of the mower body and ω_{b} is the angular velocity of the mower body. The linear/angular velocity mapping shown in FIG. 2A and 2B, and used by the Slope Compensation System 424 in FIG. 4, is as follows:

$${ω}_{p} = \frac{( {v}_{b} - \frac{{ω}_{b} l}{2} )}{r} \qquad Eq . 5$$

$${ω}_{s} = \frac{( {v}_{b} + \frac{{ω}_{b} l}{2} )}{r} \qquad Eq . 6$$

$${v}_{b} = \frac{( {ω}_{p} + {ω}_{s} ) r}{2} \qquad Eq . 7$$

$${ω}_{b} = \frac{( {ω}_{s} - {ω}_{p} ) r}{l} \qquad Eq . 8$$

The mapped wheel torques and wheel angular velocities calculated above are provided to the lower level motor drivers and controllers to determine the appropriate current/phase that is sent to the motors to compensate for the slope forces and moments imparted on the mower. For example, in some examples, the calculated torques are applied differently to each of the starboard and port wheels to control each wheel separate in order to consistently, efficiently, and safely control the mower wheels to follow a single stripe or a curve along the sloped region and to control error for that stripe of grass being mowed. Specifically, as shown in FIG. 2B which depicts a rear view of the mower on a slope, the gravity vector on the mower causes the mower to want to rotate about its Z-axis 240 such that the front castor wheel wants to move downhill In order to compensate for this gravity vector effect on the mower, additional torque τₛ 214 is applied to the starboard wheel 114s than the τₚ 210 that is applied to the port side wheel 114p.

In various examples, any one or more of the slope forces, moments, gravity measurements, wheel torques, angular velocities, or lower level commands (e.g., the current/phase commands), may be stored and/or otherwise associated with a map of the area such that a mower at a future time (either the mower or an additional mower of a fleet of mowers) may rely on the stored data (either directly or by use as an a priori estimate to be combined with newly acquired data).

In some examples, the gravity vector and slope compensation may be re-estimated after pre-defined periods of motion to eliminate noise/error that may have entered the measurements/calculations. Specifically, if one or more of the translational, side to side, up, down, orientation, rotational uncertainty reaches a certain threshold, then the system is reset by stopping for a period of about 0.1 seconds to about 5 seconds.

In some examples, the Mapping/Localization components 408, and/or the slope compensation component 424, may determine that the mower attitude exceeds a maximum slope angle for operating same. That is, once the determined mower attitude, or the wheel torques calculated to compensate for the slope forces and moments, meets or exceeds a pre-defined maximum value (i.e., a threshold value), various mower operational steps may be taken, included but not limited to, stopping the mower, angling the mower to a safe direction to operate across or parallel with the slope, or up and down the slope, determining to traverse in a direction to reduce the slope force/moment of the mower and the wheel torques while ensuring that all areas within the region are traversed, slowing the mower, change the mowing stripe pattern, and the like. In some examples, the autonomous lawn mower may operate on slope of 0-30 degrees as may be determined based at least in part on the lawn mower model and/or the slope forces/moments. In some examples, the above calculations are based on a computer model of the mower. For example, the mower has a certain three-dimensional moment which may be determined based on the computer model of the mower.

In various examples described herein, the slope compensation values (e.g., slope forces and slope moments) determined may then be transmitted or received by a system (or subcomponent of a system) for controlling the autonomous lawn mower to follow the pattern. In a non-limiting example, an autonomous lawn mower may receive the coverage plan (or mow pattern) and control one or more actuators adjusted for the slope compensation values determined to follow the pattern over a given area.

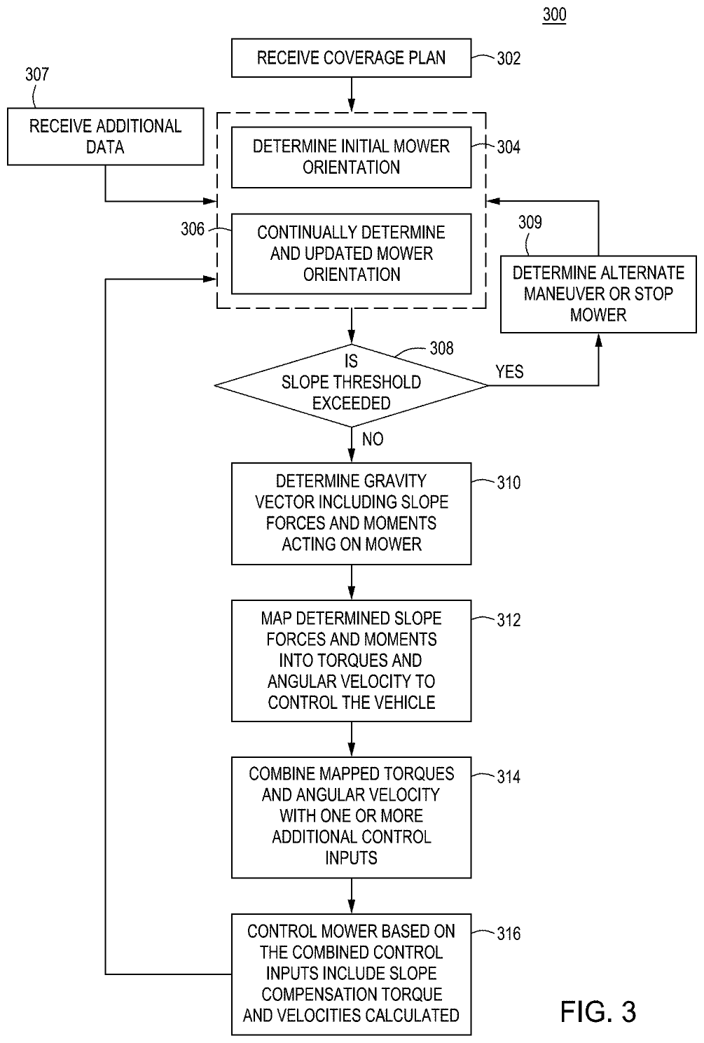

FIG. 3 illustrates an example flow diagram representing one or more of the processes as described herein. Each block of the flow diagram may represent a module of code to execute and/or combinations of hardware and/or software configured to perform one or more processes described herein. Though illustrated in a particular order, the following figures are not meant to be so limiting. Any number of blocks may proceed in any order (including being omitted) and/or substantially simultaneously (i.e., within technical tolerances of processors, etc.) to perform the operations described herein. Further, in those systems with more than one blade, the following operations depicted in any of the flow charts herein may be performed based on any one or more blades.

FIG. 3 is an example process 300 for controlling an autonomous lawn mower 102 over a sloped area 120 to compensate for the effects of operating on a sloped area 120. Such a process may begin by receiving a coverage plan of an area to be mowed that includes a sloped region 120 at 302.

At 303, the orientation of the autonomous lawn mower system is determined. Specifically, attitude estimation of the mower is performed by the Mapping/Localization components 408 as described above and below. Mower orientation is determining an initial orientation at 304 and then continuously measuring for and determining a current orientation of the lawn mower at 306 as the mower begins to move.

At 304, determining the orientation by the Mapping/Localization components 408 comprises, in at least some examples, determining the state of the lawn mower including any one or more of a roll, pitch, and/or yaw orientation and/or the surface orientation (e.g., normal) of one or more of a surface upon which the mower is currently positions or a surface proximate the lawn mower in a direction of travel of mowing. Measurements may be taken from one or more sensors onboard the lawn mower including, but not limited to, inertial measurement units (IMUs) (which, in turn, may comprise any one or more of accelerometers, gyroscopes, magnetometers, and the like), tilt meters, image sensors, lidar, radar, ultrasound, inclinometers, GPS measurements, wheel odometry, visual inertial tracking, and the like. Such measurements may be filtered (e.g., by a Bayesian filter, such as unscented Kalman filter (UKF), averaged, or otherwise processed) to remove noise. Sensor fusion techniques and algorithms may be used for combining complimentary sensors mounted on the autonomous lawn mowers for the position and attitude angle measurements.

At 306, the mower may continuously measure a current orientation of the lawn mower (e.g., while mowing or otherwise traversing an area) using at least a subset of the sensors and determine, based on the sensor data, an orientation of the mower. Measurement at 306, in some examples, may comprise the same, or similar, filters or error rejection used in calibrating the sensors. In some examples, the measurements and associated calculations used to determine the mower orientation are updated at 20-40 hertz intervals, or for example, at 30 Hertz intervals.

At 307, the autonomous lawn mower system may receive additional data. As a non-limiting example, the system may receive additional sensor data (image data, lidar data, radar data, ultrasonic data, time of flight data, and the like), map data, or otherwise to determine an orientation of the surface upon which the lawn mower is travelling and/or a portion of the surface proximate the mower (e.g., along a direction of travel of the mower). This addition data may be used to refine the orientation (i.e., determine a second orientation) that must be compensated for and mapped to control signals to control the autonomous lawn mower. In at least some examples, a relative orientation of the mower to a surface may be estimated or determined based at least in part on a surface normal of a previously determined map. In various examples, such estimated normal may be combined with other measurements and/or data (e.g., via data fusion) in order to provide a better estimate of a current orientation of the mower relative to the surface.

At 308, the autonomous lawn mower system checks to determine if the orientation of the mower and/or the slope exceeds a predefined threshold that would operation of the mower unsafe. If the slope threshold is exceeded, the method proceeds to 309 where an alternate maneuver or course of action is determined to put the mower on a safe path or stop the mower. If the slope threshold is not exceed, the method proceeds to 310.

At 310, the autonomous lawn mower system compensates for the slope the mower is operating on by the determining the gravity vector relative to the body of the mower (e.g., by slope compensation component 424 of FIG. 4). The gravity vector relative to the mower body is used to (1) determine the slope force, either to be added or subtracted, to compensate for force required by the wheels to either go up or down slopes, and (2) determine the slope moment in order to compensate for the effects of that gravity vector with to the distance from those wheels to the center of mass of the mower.

At 312, the determined slope forces and moments are mapped into torques of the two wheels that are used to control the mower (mower speed, motion, differential torque distribution between starboard and port wheels, etc.) as shown with respect to FIG. 2A and FIG. 2B and described above Similarly, at 314, the determined linear and angular velocities of the lawn mower, if any, can be mapped into angular velocities at the two wheels that are used to control the mower (mower speed, motion, differential torque distribution between starboard and port wheels, etc.) as shown with respect to FIG. 2A and FIG. 2B and described above.

The determined slope compensation forces and moments are mapped into torques of the two wheels and are used to control the mower at 312 using a feed-forward control system compensation input/values. That is, it is not a feedback control compensation, which would change control effort based on a difference calculated (e.g., follow a desired velocity and compare that against a measured velocity). Rather, the slope compensation feed-forward control compensation inputs/values due to gravity effects is one of many control input terms added together to obtain wheel torques. At 314, the determined slope compensation forces and moments that are mapped into torques of the two wheels due to gravity effects are combined with one or more of these other control input terms. For example, other control inputs may include: linear velocity feedback control (forward and backward velocity); angular velocity feedback control (rotational velocity about the vertical axis of the mower); angular direction feedback control (e.g. corrections to follow stripes); integral feedback control for the linear velocity, angular velocity, and angular direction feedback control (integrates errors to identify fixed disturbances in the system); compensation for ground friction feed-forward control; Inertial compensation feed forward control to compensate offset between the wheel axis actuation and the Center of Gravity CG); and commanded body accelerations feed-forward control. Other examples of control input terms that may be combined with the mapped torques and angular velocity may include one or more of: adaptive feedback control to handle different grass friction levels; traction control to avoid wheel slip; and friction compensation feed-forward control for changing friction effects from gravity on the drive wheel(s) and castor wheel(s).

At 316, after the torques and angular velocities are mapped to the wheels, the planning and control component 420 of FIG. 4 will control the autonomous lawn mower wheels to consistently, efficiently, and safely follow a single stripe or a curve along the sloped region and to control error for that stripe of grass being mowed while compensation for the effect of operating on sloped ground. This may be done by sending one or more control signals to the at least two independently controllable wheels, or the motors/actuators that control the wheels. The mapped wheel torques and wheel angular velocities determined are sent down, via control signals, to the lower level motor drivers and controllers (e.g., actuators 216) to determine the appropriate current/phase that is sent to the motors to compensate for the slope forces and moments imparted on the mower. For example, in some examples, the calculated torques are differently to each of the starboard and port wheels to control each wheel separate in order to consistently, efficiently, and safely control the mower wheels to follow a single stripe or a curve along the sloped region and to control error for that stripe of grass being mowed.

The method returns to 304 to determine if the orientation has changed and compensate for any changed orientation accordingly.

### Example System

FIG. 4 is an example system 400 capable of performing the operations described herein. Such a system 400 may comprise one or more of processors 402, memory 404, sensor(s) 412, communication subsystem 414, actuators 416, and power system 418. Further, though depicted in FIG. 4 as a single system 400 for illustrative purposes, the intention is not to be so limiting. For example, the system 400 may be a distributed system (either locally or non-locally), where each block may be present on (or performed by) a remote system. Further, though particular blocks are associated with individual systems or subsystems, the disclosure is not meant to be so limiting. Indeed, any block may be present in any one or more of the systems or subsystems illustrated in FIG. 8 (or not present at all).

The system 400 may include one or more processor(s) 402, any of which capable of performing the operations described herein. In some examples, the processor(s) 402 may be located remotely from the system 400. The one or more processor(s) 402 may comprise one or more central processing units (CPUs), one or more graphics processing units (GPUs), digital signal processors (DSPs), field programmable gate arrays (FPGAs), application specific integrated circuits (ASICs), or the like. In one example, the system 400 may include a model Jetson Xavier computing module available from Nvidia Corporation.

Memory 404 is an example of one or more non-transitory computer readable media capable of storing instructions which, when executed by any of the one or more processor(s) 402, cause the one or more processor(s) 402 to perform any one or more of the operations described herein (e.g., those described in reference to any of FIG. 1-7). The memory 404 can store an operating system and one or more software applications, instructions, programs, and/or data to implement the methods described herein and the functions attributed to the various systems. In various implementations, the memory 404 can be implemented using any suitable memory technology, such as static random access memory (SRAM), synchronous dynamic RAM (SDRAM), nonvolatile/Flash-type memory, or any other type of memory capable of storing information. The architectures, systems, and individual elements described herein can include many other logical, programmatic, and physical components, of which those shown in the accompanying figures are merely examples that are related to the discussion herein. Additionally, or alternatively, the memory 404 is capable of storing raw sensor data from the one or more sensor(s) 412, compressed or downsampled sensor data, output (or intermediate representations) of one or more machine learning models (e.g., feature maps of neural networks), and/or representations of the raw sensor data.

Sensor(s) 412 may comprise one or more image sensor(s), radar(s), lidar(s), ultrasonic(s), touch sensors, Global Positioning and/or Navigation Satellite Systems, inertial measurement units (IMUs)—which may comprise one or more accelerometers, gyroscopes, and/or magnetometers, and the like, encoders (which may be associated with any one or more wheels or one or more blades), orientation sensors, Hall sensors, ammeters, voltmeters, power meters, location systems, battery management systems, motor sensors, etc. Image sensors may comprise, for example, RGB cameras, intensity cameras (e.g., greyscale or monochrome), stereo cameras, depth cameras (e.g., structured light sensors, time of flight (TOF) cameras, etc.), RGB-D cameras, infrared cameras, ultraviolet cameras, hyperspectral cameras, and the like. In those examples where multiple image sensors are contemplated, various image sensors may have varying fields of view. For example, where at least two image sensors are used, one image sensor may be a narrow field of view camera and the other a wide-angle field of view camera.

Sensor(s) 412 may further include, for example, ultrasonic transducers (e.g., SONAR), thermal imaging sensors (e.g., infrared imagers), non-contact temperature sensors (e.g., sensors capable of determining the temperature of a surface), ambient light sensors (e.g., light sensors such as, but not limited to, photodiodes capable of determining an intensity of light at 600-1200 nm), humidity sensors, pressure sensors, bolometers, pyrometers, wind speed sensors, and the like. Sensor data from such other sensors may be used to generate the three-dimensional maps and/or localize the system 400, such as in mapping/localization component 408. Any of the one or more sensor(s) 412 may also be associated with a timestamp including, but not limited to, a time of day, time of month, and/or time of year (e.g., 1-16-2018 4:50am UTC).

Sensors(s) 412 may also comprise a deck sensor comprising at least one sensor for determining a height of the blades relative to the grass and/or the chassis (e.g., a Hall effect sensor), and/or at least one sensor for measuring blade rotation parameters such as RPM, velocity, torque sensor or the like.

Such an example system 400 as shown in FIG. 4 may additionally or alternatively comprise one or more communication subsystems 414. An example communication subsystem 414 may be used to send and receive data either over a wired or wireless communication protocol, as well as provide data connectivity between any one or more of the processor(s) 402, memory 404, and sensors 412. Such protocols may include, but are not limited to, WiFi (802.11), Bluetooth, Zigbee, Universal Serial Bus (USB), Ethernet, TCP/IP, serial communication, cellular transmission (e.g., 4G, 5G, CDMA, etc.) and the like. As indicated herein, such a communication subsystem 414 may be used to send data (e.g., sensor data, control signals, etc.) to other systems (e.g. cloud-based computers, etc.). In at least some examples, to minimize an amount of data transferred (as raw sensor data may amount to upwards of multiple gigabytes to multiple terabytes per day), raw sensor data from the one or more sensors 412 may be downsampled or compressed before transmission. In at least one example, sensor data (whether raw, compressed, downsampled, a representation thereof, or otherwise) may be automatically uploaded to another computing device when in a particular location (e.g., when in a shed, or other preselected user location). Representations of data may include, for example, averages of the data, feature maps as output from one or more neural networks, extracted features of the data, bounding boxes, segmented data, and the like.

The system 400 may comprise actuator(s) 416, such as, but not limited to, one or more motors to provide torque to one or more wheels associated with the system 400, a deck actuator to raise and lower a blade platform or deck (though any other actuator is contemplated), one or more motors to spin associated one or more blades for cutting, one or more brakes associated with the one or more wheels, and the like. Such actuators may further comprise, for example, electric and/or mechanical motors, hydraulics, pneumatics, and the like. Upon receiving a signal from one or more of the planning and control subsystem 420, at least a portion of the actuator(s) may actuate in order to effectuate a trajectory (steering, acceleration, wheel torque, etc.), and the like.

The actuator(s) 416 may further comprise a brake system. Such a brake system may be electronically controlled to perform braking and/or a brake assembly may be coupled to each motor to slow the rotation of each wheel independent, when braking is used to steer the mower, or slow rotation of both wheels simultaneously, when front wheel steering is used to steer the mower. In one example, the control subsystem 420 may use a friction-based braking system with friction pads (either disk, drum, or clutch style brakes) that are coupled to a motor shaft, either before or after a transmission or other gearing that may form part of each motor. The braking system may be electromagnetically actuated via a solenoid, linear actuator or other electric-motor driven mechanism. Using such a braking system enables the mower to be held at zero velocity when the mower is not being commanded to move. In addition, a friction based braking system saves power and prevents runaway mowers in the event of emergency stops or system failure. In addition to, or in lieu of, the friction braking system, the control subsystem 420 may utilize regenerative braking through control of the drive motors. In one example, regenerative braking is used for non-emergency braking during normal operation and friction braking is used during emergency stops and parking. With regenerative braking, energy from mower inertia is either transferred into the battery(ies) and/or into a brake resistor.

System 400 may also comprise a power system 418 including, but not limited to one or more of batteries, battery packs, fuel cells, super capacitors, or otherwise to provide power to the one or more processor(s) 402, actuators 416, sensor(s) 412, or any other component or subcomponent of the system 400 which requires power. The power system 418 may be removable such that the power system 418 can be removed and replaced when not operating within norms, e.g., recharge capacity is below a capacity threshold. The power system 418 may include multiple energy sources such as a battery or fuel cell for powering the mower electronics and a tank for gasoline, natural gas, hydrogen, or other fuel for powering one or more motors.

Though not illustrated for clarity, the system 400 may comprise one or more support circuits which may comprise circuits and devices that support the functionality of the processor(s) 402. The support circuits may comprise, one or more or any combination of: clock circuits, communications circuits, cache memory, power supplies, interface circuits for the various sensors, actuators, and communications circuits, and the like. More specifically, the support circuits may comprise sensor interfaces, communication circuit(s) interfaces, and actuator drive interfaces. The sensor interfaces may support data transfer from the sensor(s) 412 to the processor(s) 402 through one or more, or any combination of, data buffering/caching, signal digitizing, signal amplification, digital and/or analog signal processing, filtering, limiting, and/or the like.

The communication circuits interfaces may support data transfer to/from the communications circuits (e.g., LTE and/or WiFi transceivers) to/from the processor(s) 402 through one or more, or any combination of, digital and/or analog signal processing, filtering, limiting, amplifying, and/or the like. The communications circuits may comprise one or more communications transceivers (modems) and their associated antennas. In some examples, the communication circuits may include, but are not limited to, a pair of WiFi transceivers, a pair of LTE transceivers, or the like. The antennas generally may include a plurality of antennas to ensure diverse antenna positioning on the mower body to combat multi-path interference. A pair of transceivers may be used to provide redundancy. For example, two antennas for each transceiver (eight antennas total) are mounted on either side of the body (see FIGS. 1A and 1B). The antennas for LTE/WiFi and GNSS may be collocated in a single antenna housing (dome). One such example of such an antenna is the Combo Outdoor IP67 Roof Antenna available from Teltonika.

The actuator drive interfaces may support control of the actuators 416 (e.g., drive motors, brake system, blade motors, deck actuator, etc.) through one or more, or any combination of, current, voltage or pulse width modulated signal controllers in the form of motor controllers, brake controllers, solenoid controllers and/or the like.

Within memory 404, a calibration component 406 may perform calibration of the one or more sensor(s) 412 and/or actuators 416 with respect the autonomous lawn mower. Calibration may comprise determining one or more sensor intrinsics and/or extrinsics. Such calibration protocols performed by calibration component 406 may ensure that any one or more components or subcomponents of system 400 is working properly and enable correct calculations to be generated given the system's 400 current understanding of the relative positions, orientations, and parameters of the other components and subcomponents.

A mapping/localization component 408 may take in sensor data from any one or more of the sensor(s) 412 to map an area and/or provide a position and/or orientation of the system 400 relative to the map and relative to ground surface.

As described above, the mapping/localization component 408 may begin localization of the autonomous lawn mower system by determining the mower orientation. Determining the orientation comprises, in at least some examples, determining the state of the lawn mower including any one or more of a roll, pitch, and/or yaw orientation and/or the surface orientation (e.g., normal) of one or more of a surface upon which the mower is currently positions or a surface proximate the lawn mower in a direction of travel of mowing. Measurements may be taken from one or more sensors onboard the lawn mower including, but not limited to, inertial measurement units (IMUs) (which, in turn, may comprise any one or more of accelerometers, gyroscopes, magnetometers, and the like), tilt meters, image sensors, lidar, radar, ultrasound, and the like. Such measurements may be filtered (e.g., by a Bayesian filter, such as a Kalman filter, averaged, or otherwise processed) to remove noise. Sensor fusion techniques and algorithms may be used for combining complimentary sensors mounted on the autonomous lawn mowers for the position and attitude angle measurements.

Localization may comprise determining any one or more of biases, drifts, error, offsets, or otherwise with respect to any one or more of the associated sensors for determining an orientation of the lawn mower. In at least some examples, such biases, drifts, errors, offsets, or otherwise may be previously determined using a calibration procedure and/or continuously updated during operation of the mower. Once the initial orientation of the mower is determined, the lawn mower may continuously measure a current orientation of the lawn mower (e.g., while mowing or otherwise traversing an area) using at least a subset of the sensors and determine, based on the sensor data, an orientation of the mower. Measurement, in some examples, may comprise the same, or similar, filters or error rejection used in calibrating the sensors. Furthermore, in some examples, the autonomous lawn mower may receive additional data. As a non-limiting example, the system may receive additional sensor data (image data, lidar data, radar data, ultrasonic data, time of flight data, and the like), map data, or otherwise to determine an orientation of the surface upon which the lawn mower is travelling and/or a portion of the surface proximate the mower (e.g., along a direction of travel of the mower).

In at least one example, sensor data from the one or more sensor(s) 412 may be used to construct (and/or update) a two- and/or three-dimensional topographical map of the scanned area. When updating, preexisting map data may be received from memory 404 and/or from server 430. Multiple mapping techniques may be used to construct a two- or three-dimensional topographical map based on the acquired sensor data including, but not limited to SLAM, Kalman filters (Unscented Kalman Filters, Extended Kalman Filters, etc.), occupancy grids, bundle adjustment, sliding window filters, and the like. Such a topographical map may be stored as a signed distance function (SDF), or truncated SDF (TSDF), triangle mesh, mosaics, etc. Use of voxel hashing may improve memory requirements for both storage and raycasting. In at least some examples, sensor data may include radar data indicative of subterranean objects (e.g., pipes, golf balls, rocks, etc.). Such subterranean objects may provide features for use in creating the map. For example, locations of sprinklers, piping, rocks, moisture levels, and the like may be combined (or fused) with other sensor data to both generate the topographical maps and localize against them.

Furthermore, various combinations of sensor data may be used to provide additional insight as derived sensor data. As a non-limiting example, sensor data from wide-angle, dual baseline, image sensors may be used to reconstruct depth of the environment and provide additional features for use in generating the map and or localizing the system 400 against such a map. Any such derived sensor data may be either used for mapping and/or localization, as well as may be associated with the map after it has been generated (e.g., storing the value associated with the portion of the map where the data was collected). Further, in at least some examples, control signals (as may be received and/or generated by system 400) may be associated with the map at mapping and localization component 408. In some examples, GNSS data may be used to inform a Region of Interest (ROI) of satellite imagery to download to, or otherwise augment, the two- or three-dimensional topographical map. Additionally, or alternatively, such a system 400 may download, or otherwise access, weather data as additional sensor data. The weather data may be indicative of, for example, weather conditions for the time of day associated with the other sensor data.

Such maps may comprise signed distance functions (SDFs) or truncated signed distance functions TSDFs, mesh representations, UTM grids, mosaics, tiles, etc., including any topological relationship between such sensor data. In some examples, voxel hashing may be used to minimize memory requirements for both map storage and retrieval. Such a map may also be associated with additional sensor data (and/or data derived from the additional sensor data, such as segmentations, classifications, output from machine learning algorithms, etc.). For example, moisture level data, soil density data, vegetative health indicators (growth, absence of growth, presence of pests, presence of weeds or invasive species, etc.), thermal data, ambient light data, etc. may be associated with every location in the three-dimensional map. Additionally, or alternatively, image sensor data (e.g., color) may be associated with the map as well (e.g., by weighted averaging, or the like), so that a user viewing the map would quickly see a virtual representation of the scanned area, including color.

Once a two- and/or three-dimensional topographical map is generated, that information, the topographical information included in the map could be used to compensate for slopes directly on the coverage plan. In that way, the autonomous lawn mower path would be determined ahead of time based on slope compensation values in order to create a desired mowing stipe pattern for the sloped area being mowed. For example, a user may decide that the mowing stripes go laterally to slopes, and the coverage plan would include a path for the mower to follow along the slope to create the desired pattern.

The planning and control subsystem 420 may determine commands for operating one or more of the actuator(s) 416. In some examples, such a planning and control subsystem 420 may include a slope compensation component 424 for determine wheel torques and angular velocities to compensate for operating on a sloped region as described above. The slope compensation component 424 receives orientation information from the mapping/localization 408 component in order to determine slope force, slope moments, and linear/angular velocities of the autonomous lawn mower cause by gravity and exerted on the mower operating on a slope. Those values are then mapped to independent starboard and port side wheel torques and angular velocities. The starboard and port side wheel torques and angular velocities are transformed into current/phase information to control the motors that control each wheel in order to compensate for operating on the slope, and to consistently, efficiently, and safely control the mower wheels to follow a single stripe or a curve along the sloped region and to control error for that stripe of grass being mowed.

In addition or alternatively, in some examples, such a planning and control subsystem 420 may determine one or more trajectories for the system 400 to follow (e.g., by determining a series of steering commands, acceleration commands, etc. which cause the system 400 to follow an intended pattern). Such trajectories may be determined in accordance with waypoints (e.g., GNSS-based waypoints) as may be received from a user via control interface (not shown) and/or calculated to optimize (e g , minimize) a length of travel over a defined region of interest (e.g., as may be determined by server 430), a quality of cut, or a time to mow an area, for example. Such calculations may be determined, for example, using Bellman Ford's algorithm, Dijkstra's Algorithm, or otherwise. In various examples, one or more of the waypoints and/or trajectories may be based at least in part on a coverage plan received from one or more of coverage planner 422 or coverage planner 438.

In any such example provided herein, such trajectories and/or controls may be calculated iteratively (and/or periodically) such that the system 400 (and/or associated user(s)) always has the most relevant information.

### Example Clauses

A. An autonomous lawn mower comprising: a sensor; at least two independently controllable wheels; one or more processors; and one or more non-transitory computer readable media having instructions stored thereon which, when executed by the one or more processors cause the one or more processors to perform operations comprising: receiving a coverage plan of an area to be mowed that includes a sloped region; receiving sensor data from the sensor; determining, based at least in part on the sensor data, a gravity vector relative to an orientation of the autonomous lawn mower; determining, based at least in part on the gravity vector and a model of the autonomous lawn mower, a slope force; determining, based at least in part on the slope force, a set of torques to be applied to the at least two independently controllable wheels, the set of torques determined such that when applied to the at least two independently controllable wheels the autonomous lawn mower continues along the coverage plan; and causing the set of torques to be applied to the at least two independently controllable wheels.

B. The autonomous lawn mower described in clause A, wherein determining the control signals comprises applying different torques to each of the independently controllable wheels, and transmitting the control signals to motors that drive the wheels to compensate for the slope forces and slope moments imparted on the autonomous lawn mower.

C. The autonomous lawn mower described in clause A or B, the operations further comprising: determining a slope associated with the position of the autonomous lawn mower; determining the slope meets or exceeds a threshold slope value; and causing the autonomous lawn mower to perform a maneuver other than following the coverage plan.

D. The autonomous lawn mower described in clauses A-C, wherein the maneuver comprises one or more of: a stop maneuver, or a maneuver to cause the autonomous lawn mower to traverse in a direction up and down the slope.

E. The autonomous lawn mower described in clauses A-D, wherein determining the gravity vector is performed at a frequency of about 20 hertz to about 40 hertz intervals.

F. The autonomous lawn mower described in clauses A-E, wherein the sensor comprises one or more of an inertial measurement units (IMU), an accelerometer, a gyroscope, a magnetometers, a tilt meters, an image sensor, a lidar, a radar, an ultrasonic transducer, an inclinometer, a GNSS, a wheel odometer, or a camera.

G. The autonomous lawn mower described in clauses A-F, wherein the operations further comprise: receiving map data associated with a location of the autonomous lawn mower, the map data comprising a surface topography; and determining, based at least in part on the map data, a surface normal associated with the location of the autonomous lawn mower, wherein determining the slope force is further based at least in part on the surface normal.

H. The autonomous lawn mower described in clauses A-G, wherein determining the set or torques comprises: determining, based at least in part on the slope force, one or more of a linear velocity or an angular velocity associated with the at least two independently controllable wheels.

I. The autonomous lawn mower described in clauses A-H, wherein the operations further comprise: associating one or more of the set of torques, the slope force, or the gravity vector with a map, wherein the map is accessible by the autonomous lawn mower or an additional autonomous lawn mower.

J. A method for controlling a lawn mower comprising: following a route by a lawn mower for mowing an area; receiving sensor data from a sensor associated with the lawn mower; determining, based at least in part on the sensor data, a gravity vector relative to an orientation of the lawn mower; determining, based at least in part on the gravity vector and as a slope force, a force to compensate for a torque on the lawn mower caused by the gravity vector; determining, based at least in part on the slope force, a torque to be applied to a wheel of the lawn mower; and causing the lawn mower to apply the torque at the wheel.

K. The method described in clause J, wherein the torque is one of a set of torques and the wheel is one of at least two wheels, and causing the lawn mower to apply the torque at the wheel comprises applying different torques to the at least two wheels, and transmitting the control signals to motors that drive the wheels to compensate for the slope forces and slope moments imparted on the lawn mower.

L. The method described in clause J or K, the method further comprising: determining a slope associated with the position of the autonomous lawn mower; determining the slope meets or exceeds a threshold slope value; and causing the autonomous lawn mower to perform a maneuver other than following the coverage plan.

M. The method described in any of clauses J-L, wherein the maneuver comprises one or more of: a stop maneuver, or a maneuver to cause the autonomous lawn mower to traverse in a direction up and down the slope.

N. The method described in any of clauses J-M, wherein determining the gravity vector is performed at a frequency of about 20 hertz to about 40 hertz intervals.

O. The method described in any of clauses J-N, wherein the operations further comprise: receiving map data associated with a location of the autonomous lawn mower, the map data comprising a surface topography; and determining, based at least in part on the map data, a surface normal associated with the location of the autonomous lawn mower, wherein determining the slope force is further based at least in part on the surface normal.

P. The method described in any of clauses J-O, wherein the operations further comprise: associating one or more of the set of torques, the slope force, or the gravity vector with a map, wherein the map is accessible by the autonomous lawn mower or an additional autonomous lawn mower.

Q. One or more non-transitory computer readable media having instructions stored thereon which, when executed by one or more processors, cause the one or more processors to perform operations comprising following a route by a lawn mower for mowing an area; receiving sensor data from a sensor associated with the lawn mower; determining, based at least in part on the sensor data, a gravity vector relative to an orientation of the lawn mower; determining, based at least in part on the gravity vector and as a slope force, a force to compensate for a torque on the lawn mower caused by the gravity vector; determining, based at least in part on the slope force, a torque to be applied to a wheel of the lawn mower; and causing the lawn mower to apply the torque at the wheel.

R. The one or more non-transitory computer readable media described in clause Q, wherein the torque is one of a set of torques and the wheel is one of at least two wheels, and causing the lawn mower to apply the torque at the wheel comprises applying different torques to the at least two wheels, and transmitting the control signals to motors that drive the wheels to compensate for the slope forces and slope moments imparted on the lawn mower.

S. The one or more non-transitory computer readable media described in either clause Q or R, wherein the operations further comprise: determining a slope associated with the position of the autonomous lawn mower; determining the slope meets or exceeds a threshold slope value; and causing the autonomous lawn mower to perform a maneuver other than following the coverage plan.

T. The one or more non-transitory computer readable media described in any of clauses Q-S, wherein the maneuver comprises one or more of: a stop maneuver, or a maneuver to cause the autonomous lawn mower to traverse in a direction up and down the slope.

### Conclusion

Here multiple examples have been given to illustrate various features and are not intended to be so limiting. Any one or more of the features may not be limited to the particular examples presented herein, regardless of any order, combination, or connections described. In fact, it should be understood that any combination of the features and/or elements described by way of example above are contemplated, including any variation or modification which is not enumerated, but capable of achieving the same. Unless otherwise stated, any one or more of the features may be combined in any order.

As above, figures are presented herein for illustrative purposes and are not meant to impose any structural limitations, unless otherwise specified. Various modifications to any of the structures shown in the figures are contemplated to be within the scope of the systems, techniques, and processes presented herein. Such systems, techniques, processes, etc. are not intended to be limited to any scope of claim language.

Where “coupling” or “connection” is used, unless otherwise specified, no limitation is implied that the coupling or connection be restricted to a physical coupling or connection and, instead, should be read to include communicative couplings, including wireless transmissions and protocols.

Any block, step, module, or otherwise described herein may represent one or more instructions which can be stored on a non-transitory computer readable media as software and/or performed by hardware. Any such block, module, step, or otherwise can be performed by various software and/or hardware combinations in a manner which may be automated, including the use of specialized hardware designed to achieve such a purpose. As above, any number of blocks, steps, or modules may be performed in any order or not at all, including substantially simultaneously, i.e., within tolerances of the systems executing the block, step, or module.

Where conditional language is used, including, but not limited to, “can,” “could,” “may” or “might,” it should be understood that the associated features or elements are not required. As such, where conditional language is used, the elements and/or features should be understood as being optionally present in at least some examples, and not necessarily conditioned upon anything, unless otherwise specified.

Where lists are enumerated in the alternative or conjunctive (e.g. one or more of A, B, and/or C), unless stated otherwise, it is understood to include one or more of each element, including any one or more combinations of any number of the enumerated elements (e.g., A, AB, AB, ABC, ABB, etc.). When “and/or” is used, it should be understood that the elements may be joined in the alternative or conjunctive.

What is claimed is:

1. An autonomous lawn mower comprising:
a sensor;
at least two independently controllable wheels;
one or more processors; and
one or more non-transitory computer readable media having instructions stored thereon which, when executed by the one or more processors cause the one or more processors to perform operations comprising:
receiving a coverage plan of an area to be mowed that includes a sloped region;
receiving sensor data from the sensor;
determining, based at least in part on the sensor data, a gravity vector relative to an orientation of the autonomous lawn mower;
determining, based at least in part on the gravity vector and a model of the autonomous lawn mower, a slope force;
determining, based at least in part on the slope force, a set of torques to be applied to the at least two independently controllable wheels, the set of torques determined such that when applied to the at least two independently controllable wheels the autonomous lawn mower continues along the coverage plan; and
causing the set of torques to be applied to the at least two independently controllable wheels.

2. The autonomous lawn mower of claim 1, wherein causing the set of torques to be applied to the at least two independently controllable wheels includes transmitting the control signals to motors that drive the wheels to compensate for the slope forces and slope moments imparted on the autonomous lawn mower.

3. The autonomous lawn mower of claim 1, the operations further comprising:
determining a slope associated with a position of the autonomous lawn mower;
determining the slope meets or exceeds a threshold slope value; and
causing the autonomous lawn mower to perform a maneuver other than following the coverage plan.

4. The autonomous lawn mower of claim 3, wherein the maneuver comprises one or more of:
a stop maneuver, or
a maneuver to cause the autonomous lawn mower to traverse in a direction up and down the slope.

5. The autonomous lawn mower of claim 1, wherein determining the gravity vector is performed at a frequency of about 20 hertz to about 40 hertz intervals.

6. The autonomous lawn mower of claim 1, wherein the sensor comprises one or more of an inertial measurement units (IMU), an accelerometer, a gyroscope, a magnetometers, a tilt meters, an image sensor, a lidar, a radar, an ultrasonic transducer, an inclinometer, a GNSS, a wheel odometer, or a camera.

7. The autonomous lawn mower of claim 1, wherein the operations further comprise:
receiving map data associated with a location of the autonomous lawn mower, the map data comprising a surface topography; and
determining, based at least in part on the map data, a surface normal associated with the location of the autonomous lawn mower,
wherein determining the slope force is further based at least in part on the surface normal.

8. The autonomous lawn mower of claim 1, wherein determining the set or torques comprises:
determining, based at least in part on the slope force, one or more of a linear velocity or an angular velocity associated with the at least two independently controllable wheels.

9. The autonomous lawn mower of claim 1, wherein the operations further comprise:
associating one or more of the set of torques, the slope force, or the gravity vector with a map,
wherein the map is accessible by the autonomous lawn mower or an additional autonomous lawn mower.

10. A method comprising:
following a route by a lawn mower for mowing an area;
receiving sensor data from a sensor associated with the lawn mower;
determining, based at least in part on the sensor data, a gravity vector relative to an orientation of the lawn mower;
determining, based at least in part on the gravity vector and as a slope force, a force to compensate for a torque on the lawn mower caused by the gravity vector;
determining, based at least in part on the slope force, a torque to be applied to a wheel of the lawn mower; and
causing the lawn mower to apply the torque at the wheel.

11. The method of claim 10, wherein the torque is one of a set of torques and the wheel is one of at least two wheels, and causing the lawn mower to apply the torque at the wheel comprises applying different torques to the at least two wheels, and transmitting control signals to motors that drive the wheels to compensate for the slope forces and slope moments imparted on the lawn mower.

12. The method of claim 10, the method further comprising:
determining a slope associated with a position of the lawn mower;
determining the slope meets or exceeds a threshold slope value; and
causing the lawn mower to perform a maneuver other than following the route.

13. The method of claim 12, wherein the maneuver comprises one or more of:
a stop maneuver, or
a maneuver to cause the lawn mower to traverse in a direction up and down the slope.

14. The method of claim 12, wherein determining the gravity vector is performed at a frequency of about 20 hertz to about 40 hertz intervals.

15. The method of claim 10, wherein the method further comprise:
receiving map data associated with a location of the lawn mower, the map data comprising a surface topography; and
determining, based at least in part on the map data, a surface normal associated with the location of the lawn mower,
wherein determining the slope force is further based at least in part on the surface normal.

16. The method of claim 10, wherein the method further comprise:
associating one or more of the torque, the slope force, or the gravity vector with a map, wherein the map is accessible by the lawn mower or an additional lawn mower.

17. One or more non-transitory computer readable media having instructions stored thereon which, when executed by one or more processors, cause the one or more processors to perform operations comprising:
following a route by a lawn mower for mowing an area;
receiving sensor data from a sensor associated with the lawn mower;
determining, based at least in part on the sensor data, a gravity vector relative to an orientation of the lawn mower;
determining, based at least in part on the gravity vector and as a slope force, a force to compensate for a torque on the lawn mower caused by the gravity vector;
determining, based at least in part on the slope force, a torque to be applied to a wheel of the lawn mower; and
causing the lawn mower to apply the torque at the wheel.

18. The one or more non-transitory computer readable media of claim 17, wherein the torque is one of a set of torques and the wheel is one of at least two wheels, and causing the lawn mower to apply the torque at the wheel comprises applying different torques to the at least two wheels, and transmitting control signals to motors that drive the wheels to compensate for the slope forces and slope moments imparted on the lawn mower.

19. The one or more non-transitory computer readable media of claim 17, wherein the operations further comprise:
determining a slope associated with a position of the lawn mower;
determining the slope meets or exceeds a threshold slope value; and
causing the lawn mower to perform a maneuver other than following the route.

20. The one or more non-transitory computer readable media of claim 19, wherein the maneuver comprises one or more of:
a stop maneuver, or
a maneuver to cause the lawn mower to traverse in a direction up and down the slope.
